(19) United States
(12) Patent Application Publication
(10) Pub. No.: US 2024/0338509 A1
(43) Pub. Date: Oct. 10, 2024

(54) Method for determining computing hardware architectures

(71) Applicant: COMMISSARIAT A L’ENERGIE ATOMIQUE ET AUX ENERGIES ALTERNATIVES, PARIS (FR)

(72) Inventors: Lilia ZAOURAR, GIF-SUR-YVETTE (FR); Jean-Marc PHILIPPE, GIF-SUR-YVETTE (FR)

(21) Appl. No.: 18/628,189

(22) Filed: Apr. 5, 2024

(30) Foreign Application Priority Data
Apr. 6, 2023 (FR) 2303453

(51) Int. Cl. G06F 30/398; G06F 111/10

(52) U.S. Cl. CPC G06F 30/398; G06F 2111/10

(57) ABSTRACT

A method for determining a hardware architecture for an integrated circuit is provided, this method comprising a plurality of iterations of steps of: applying an optimization algorithm to an architecture exploration space to determine at least one candidate architecture configuration, the space containing functions evaluating optimization criteria; applying the configuration to evaluation tools; determining at least two main optimization criteria chosen from the computational performance, power consumption and/or surface area of the circuit, a main criterion being determined on the basis of the results of the evaluation tools and a technological database; determining whether a termination criterion is verified. In each iteration, the determination of the configuration is optimized via the evaluation of the functions relating to the main criteria. The iterations are terminated in response to the verification of the termination criterion and at least one optimized configuration is generated.

### CROSS-REFERENCE TO RELATED APPLICATION

This application claims priority to foreign French patent application No. FR 2303453, filed on Apr. 6, 2023, the disclosure of which is incorporated by reference in its entirety.

### FIELD OF THE INVENTION

The present invention generally relates to electronic systems, and in particular to a method for determining computing hardware architectures through exploration of the design space.

### BACKGROUND

Computing hardware architectures are conventionally used as basic elements for the design of systems-on-chip.

A system-on-chip (abbreviated SoC) corresponds to a complete system embedded in an integrated circuit comprising a multitude of electrical or electronic components. Such an integrated circuit implements characteristic functionalities associated with a specific application or application domain, and generic elements, such as processor cores, storage elements or even inputs/outputs. An integrated circuit comprises a hardware device that is generally associated with software configured to control the hardware device and in particular to implement the characteristic functionalities. The hardware device comprises, in particular in so-called high-performance SoCs, a multi-core hardware architecture (i.e. one composed of a plurality of computing cores) and is produced from assembled hardware bricks. Design of the hardware device comprises development of the hardware architecture of the various basic bricks and their configuration using known CAD tools (CAD standing for Computer Aided Design), according to a design flow. A design flow comprises a set of steps implemented using a high number of tools. Such tools allow the actual design (for example transformation of a high-level description of the architecture into a lower-level description) and evaluation of instances of possible architecture configurations. Such tools are also used to validate the complete design of an SoC circuit.

As the complexity of integrated circuits increases, such a design flow leads to an increase in the design space for exploration, this potentially resulting in multiple iterations in each stage of the design flow, more complex tools and difficulties in linking various tools, and to an increase in the cost of the necessary resources.

Various design methods and tools have been provided to try to improve the design flow of computing hardware architectures. Known methods use manual or dynamic design flows that employ various simulators to explore the design space and defined architecture configurations by applying an optimization algorithm, as described for example in the article “An Automatic Design Space Exploration Framework for Multicore Architecture Optimizations” by H. Calborean et al., 9th RoEduNet, vol. 14, 2010, or as described for example in the article “Multilevel simulation-based co-design of next generation HPC microprocessors” by L. Zaourar et al., International Workshop PMPBS (PMBS), Super Computing, St. Louis, United States, 2021.

However, such methods do not allow a dynamic design flow to be obtained that is capable of determining the best configurations by optimally taking into account all the various results delivered by the available evaluation and design tools, for the exploitation of a wide choice of evaluation parameters. These methods also do not allow a multi-level view of the design of an integrated circuit to be supported, in which the results of a design level may be reused to improve the results of a previous level.

There is thus a need for a method capable of optimizing determination of the computing hardware architectures to be used in the design of an integrated circuit.

### SUMMARY OF THE INVENTION

The present invention improves the situation by providing a computer-implemented method for determining a hardware architecture for an integrated circuit. The method comprises at least a plurality of iterations of the following steps:
applying an optimization algorithm A to an architecture exploration space E, so as to determine at least one candidate architecture configuration G, the candidate architecture configuration G belonging to the architecture exploration space E, the architecture exploration space E containing a set of objective functions F evaluating optimization criteria C_{q} associated with the candidate architecture configuration G;
applying the candidate architecture configuration G to a plurality of evaluation tools Oₘ, this delivering results of evaluation of the candidate architecture configurations G;
determining a value of at least two optimization criteria C_{q}, the at least two optimization criteria, which are called the main optimization criteria, being chosen from the computational performance, power consumption and/or surface area of the integrated circuit to be designed, the value of one of the main optimization criteria being determined by applying an analytical function [symbol] taking as arguments at least one circuit information item and at least one technological information item, the at least one circuit information item being determined on the basis of the evaluation results delivered by at least one evaluation tool Oₘ among the evaluation tools Oₘ, the at least one technological information item being obtained from at least one technological database; and
determining whether a termination criterion is verified.

In each iteration, the determination of the candidate architecture configuration G is optimized on the basis of the evaluation of the objective functions F relating to the determined values of the at least two main optimization criteria C_{q}.

The method further comprises terminating the iterations in response to the verification of the termination criterion and generating at least one optimized computing-architecture configuration Gₒₚₜ on the basis of the at least one architecture configuration G.

In embodiments, the termination criterion may be defined as a function of an evaluation of at least one objective function Fₕ relating to a main optimization criterion C_{q}, on the basis of the determined value of the main optimization criterion.

Alternatively, the termination criterion may be defined as a function of a predefined execution time of the plurality of iterations of optimization steps.

Advantageously, each evaluation tool Oₘ may be configured to generate a set of evaluation results R_{mg} associated with the at least one architecture configuration G. The method may further comprise a step of applying the candidate architecture configuration G to a first evaluation tool Oₘ among the evaluation tools Oₘ, on the basis of at least one evaluation result R_{mg} obtained in a prior step of applying the candidate architecture configuration G to a second evaluation tool Oₘ among the evaluation tools Oₘ.

The at least one architecture configuration G may be generated as a function of said plurality of usable evaluation tools Oₘ.

According to embodiments, the method may further comprise a prior step of receiving an architecture descriptor D and a step of generating the architecture exploration space E on the basis of the architecture descriptor D and of the optimization algorithm A.

Advantageously, one evaluation tool Oₘ of the plurality of evaluation tools Oₘ may be an evaluation tool chosen from an architecture configuration simulator, an architecture compilation tool, a consumption evaluation tool, a tool based on an exploitation of a database and a tool based on an exploitation of a memory of candidate configuration data. The memory of candidate configuration data may be used to save evaluation results obtained in the step of applying candidate architecture configurations G and/or in the step of determining the value of optimization criteria C_{q} of candidate architecture configurations G.

Another subject of the invention is an integrated-circuit hardware architecture obtained by implementing the determining method.

The invention further provides a method for designing an integrated circuit, comprising implementing an integrated circuit on the basis of the integrated-circuit hardware architecture.

The invention also provides a computer program product comprising program code instructions implementable by a computer, the computer being able to implement the method for determining a hardware architecture of an integrated circuit.

The method for determining computing hardware architectures according to the embodiments of the invention makes it possible to optimize the exploration of the design space and of the architecture configurations to be analysed, with a view to designing an optimized integrated circuit.

Embodiments of the invention thus provide a fast, flexible, and effective solution allowing a complex system-on-chip architecture to be determined. Such a solution has the advantage of not only being ‘multi-level’, in that it is applicable to various levels in the architecture of the integrated circuit (i.e. to the complete system, to the system architecture including the interconnections between the basic elements, or even to the microarchitecture of the basic elements of the integrated circuit), while permitting wide, but also ‘single objective’ or ‘multi-objective’ exploration. The design space may be explored on the basis of execution and of various combinations of these various and varied, functional or extra-functional for example, evaluation tools.

The result is an unintrusive solution suitable for various existing methods of conventional circuit design flows (for example for RTL code generation, logic synthesis, routing placement, etc.). In particular, the method for determining computing hardware architectures according to the embodiments is adaptable to any design flow. Such a method does not require modification of the steps usually implemented in a conventional circuit design flow and allows steps to be easily added. Furthermore, such a method requires little so-called confidential information of a conventional design flow, such as information originating from RTL code.

### BRIEF DESCRIPTION OF THE DRAWINGS

Other features, details and advantages of the invention will become apparent on reading the description provided with reference to the appended drawings, which are given by way of example.

FIG. 1 is a flowchart showing the steps of the method for designing integrated-circuit hardware architectures, according to embodiments of the invention.

FIG. 2 is a schematic showing an overall structure of an integrated-circuit hardware-architecture design flow, according to embodiments of the invention.

### DETAILED DESCRIPTION

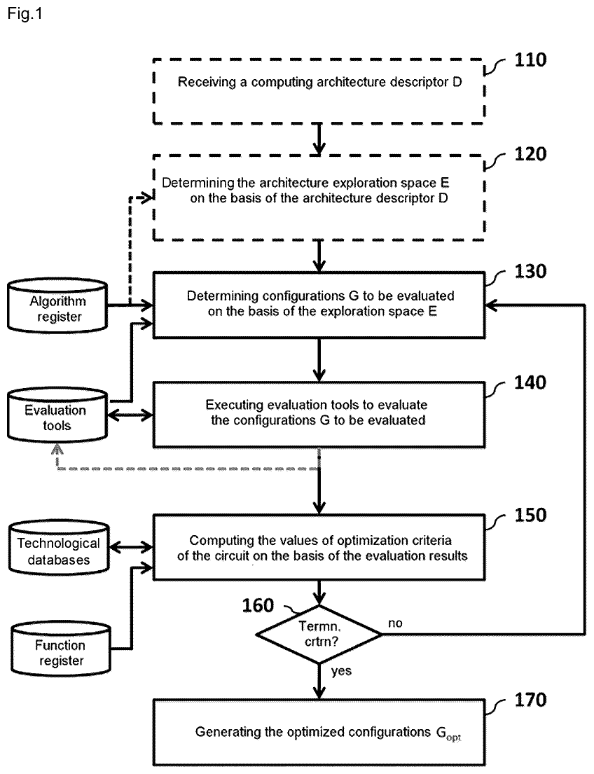

FIG. 1 shows a method for determining an integrated-circuit hardware architecture, according to certain embodiments of the invention.

The integrated-circuit hardware architecture determined via such a method makes it possible to generate a hardware description file for an integrated circuit (an SoC for example). The hardware description file of the integrated circuit may be written in hardware description language, for example and non-limitingly in VHDL or Verilog. Such a hardware description file will then be used to design the integrated circuit using an existing integrated-circuit design method. The integrated circuit is potentially capable of executing all types of computations, and in particular complex computations.

The integrated circuit may be used in or defined for many applications and varied technical fields. The integrated circuit may be used, for example and non-limitingly, in telecommunication systems, in imaging systems, in industrial systems (such as cybersecurity systems, in systems associated with manufacturing processes for example), in systems specific to the banking or tax field, or in systems for performing scientific computations, such as high-performance computing (HPC) systems, etc.

The method for determining integrated-circuit hardware architecture according to the embodiments of the invention makes it possible to determine the integrated-circuit hardware architecture on the basis of a descriptor D of the architecture and/or of an architecture exploration space E. The hardware architecture determined by the method according to the embodiments of the invention is advantageously optimized according to various optimization criteria to allow efficient execution of complex or specific computations by the integrated circuit.

The architecture descriptor D corresponds to a first representation (also called the ‘internal representation’ or ‘architectural representation’) of a hardware-architecture design optimization problem. The architecture exploration space E corresponds to a second representation (also called the ‘mathematical representation’) of this hardware-architecture design optimization problem. The exploration space E may thus be a translation of the internal representation into a mathematical representation.

The architecture descriptor D and/or the architecture exploration space E comprise/comprises a set of elements allowing an integrated-circuit hardware architecture to be defined (or described or modelled), such as parameters of the integrated circuit to be designed (for example structural parameters related to the components and/or resources of the circuit), objectives of optimization of the circuit (related for example to the performance and/or consumption and/or dimensions of the circuit) and/or constraints of the integrated circuit to be designed.

The integrated circuit may for example be a heterogeneous HPC processor comprising a plurality of computing cores and various constituent elements (or integrated-circuit components such as memories). In such an example, the parameters of the integrated circuit to be designed may comprise the types of computing core, the number of each type of computing core, memory hierarchy, the memory bandwidth and whether prefetching (or preloading) is employed, and/or how the various computing resources are interconnected (for example a network-on-chip or NoC may be used), etc.

In embodiments, the objectives of the integrated circuit to be designed may for example comprise maximization of the computational performance of the integrated circuit, minimization of the power consumption of the integrated circuit, and/or minimization of the area (or size) of the integrated circuit. In particular, computational performance may for example be associated with a time-related datum such as the latency or the frequency of execution of computations, performance also potentially being related to peak computing power (for example the number of computing elements in the integrated circuit and their size) and/or the memory footprint of the hardware architecture (for example the number of memory elements in the integrated circuit and their size).

The constraints of the integrated circuit to be designed may for example be design constraints relating to the predetermined parameters of the circuit and/or to the objectives, or even known physical constraints.

In embodiments, the architecture descriptor D may be represented in a format specific to a design flow to be implemented by the method according to the embodiments of the invention to produce the integrated circuit. For example, the architecture descriptor D may be implemented in the form of a computer file of the ‘computing architecture template’ type. The architecture descriptor D may comprise a so-called high-level description of the parameters, objectives and/or constraints of the integrated circuit to be designed. For example and non-limitingly, the architecture descriptor D may be a text file and/or an XML file containing a number of cores, their type, their size, a number of memories, a number of interconnect networks, a number of buses, a number of NoC, the position of the routers, topology, etc.

The exploration space E may comprise one or more data structures. In particular, a data structure may comprise a set P of N parameters to be optimized Pₙ (also called parameters to be explored or decision variables) of the integrated circuit to be designed. The index ‘n’ associated with various parameters to be optimized is thus an integer between 1 and N. The set P may be defined according to the following expression (01):

$$P = \{ {P}_{1} , … , {P}_{N} \} and P ∈ E \qquad ( 01 )$$

For each parameter Pₙ, a data structure of the exploration space E may also comprise one or more sets Lₙ of sub-parameters associated with the parameter Pₙ. Thus, each set Lₙ may comprise Kₙ sub-parameters [symbol] ₙₖ to be optimized of the integrated circuit to be designed. The integer Kₙ is an integer that varies as a function of the parameter Pₙ in question. The index ‘k’ associated with various sub-parameters of the set Lₙ is thus an integer between 1 and Kₙ. The set Lₙ may be defined according to the following expression (02):

$${L}_{n} = \{ {ℓ}_{n 1} , … , {ℓ}_{n {K}_{n}} \} and {L}_{n} ∈ E \qquad ( 02 )$$

In embodiments, a set L may also be associated with a sub-parameter [symbol] ₙₖ. Thus, a set Lₙₖ may be defined according to the following expression (03):

$${L}_{n k} = \{ {ℓ}_{n k ( 1 )} , … , {ℓ}_{n k ( {K}_{n k} )} \} and {L}_{n k} ∈ E \qquad ( 03 )$$

Thus, the one or more data structures of the exploration space E comprising the various sets P and L may be structured hierarchically as a function of the dependencies between parameters and sub-parameters.

Furthermore, a data structure of the exploration space E may comprise a set F of H objective and/or constraint functions Fₕ of the integrated circuit to be designed, and may be defined according to the following expression (04):

$$F = \{ {F}_{1} , … , {F}_{H} \} and F ∈ E \qquad ( 04 )$$

The set P and/or the one or more sets L and/or the set F may for example be implemented in the form of matrices, arrays, lists or vectors. The values N, K, and H are integers greater than or equal to 2.

For example and non-limitingly, a set (or list) P of parameters Pₙ to be optimized for an integrated circuit comprising a plurality of computing cores may be defined according to the following enumeration (05):

$$P = \{ ‘ {P}_{1} : number of cores ’ , ‘ {P}_{2} : type of each core ’ , \\ ‘ {P}_{3} : parameters of the memory hierarchy ’ , \\ ‘ {P}_{4} : memory bandwidth ’ , ‘ {P}_{5} : NoC / interconnection ’ , \\ ‘ {P}_{6} : presence of a memory prefetching mechanism ’ \} \qquad ( 05 )$$

The list P may thus comprise, according to the preceding enumeration (05), the number of cores of the integrated circuit, the type of each core of the integrated circuit, the parameters of the cache hierarchy of the integrated circuit, the bandwidth of the memory of the integrated circuit (or memory bandwidth), the type of NoC interconnection network of the integrated circuit, and/or the presence or absence of a memory prefetching mechanism in the integrated circuit, etc. It will be noted that if the presence of a memory prefetching mechanism in the integrated circuit is confirmed, sub-parameters may comprise the type and/or size of the memory prefetching mechanism.

A set Lₙ of sub-parameters [symbol] ₙₖ may for example correspond to a plurality of possible values, quantities or metrics associated with each parameter Pₙ of the preceding set P. For example and non-limitingly, a set (or list) Lₙ may be defined according to the following enumerations (06) and (07):
for the parameter ‘P₃: NoC/interconnection’ of the list P, the list L₅ may be:

$${L}_{5} = \{ ‘ {ℓ}_{51} : topology of the NoC interconnection network ’ , \\ ‘ {ℓ}_{52} : routing algorithm ’ , ‘ {ℓ}_{53} : number of routers ’ , \\ ‘ {ℓ}_{54} : position of the routers ’ , ‘ {ℓ}_{55} : type of the routers ’ \} \qquad ( 06 )$$

for the parameter ‘P₃: parameters of the memory hierarchy’ of the list P, the list L₃ may be:

$${L}_{3} = \{ ‘ {ℓ}_{31} : instruction cache no . 1 ’ , \\ ‘ {ℓ}_{32} : data cache no . 1 ’ , ‘ {ℓ}_{33} : instruction cache no . 2 ’ , \\ ‘ {ℓ}_{34} : data cache no . 1 ’ , ‘ {ℓ}_{35} : size of the system level cache ’ , \\ ‘ {ℓ}_{36} : size of the last level cache ’ \} \qquad ( 07 )$$

A list Lₙ (and in particular the preceding list L₃) may thus comprise, according to the preceding enumeration (06), instruction caches, data caches, the size of the system level cache (abbreviated SLC), and/or the size of the last level cache (abbreviated LLC), etc.

Moreover, for example for the parameter ‘P₃: parameters of the memory hierarchy’ of the list P, a set (or list) Lₙₖ may be defined according to the following enumerations (08), (09), (10) and (11):
for the sub-parameter ‘ [symbol] ₃₁: instruction cache no. 1’ of the list L₃, the list L₃₁ may be:

$${L}_{31} = \{ ‘ {ℓ}_{31 ( 1 )} : cache line size ’ , \\ ‘ {ℓ}_{31 ( 2 )} : associativity ’ , ‘ {ℓ}_{31 ( 3 )} : size of the instruction cache ’ , \\ ‘ {ℓ}_{31 ( 4 )} : exclusivity ’ , ‘ {ℓ}_{31 ( 5 )} : replacement policy ’ , \\ ‘ {ℓ}_{31 ( 6 )} : size of the write memory buffer ’ , ‘ {ℓ}_{31 ( 7 )} : prefetch ’ \} \qquad ( 08 )$$

for the sub-parameter ‘ [symbol] ₃₂: data cache no. 1’ of the list L₃, the list L₃₂ may be:

$${L}_{32} = \{ ‘ {ℓ}_{32 ( 1 )} : cache line size ’ , \\ ‘ {ℓ}_{32 ( 2 )} : associativity ’ , ‘ {ℓ}_{32 ( 3 )} : size of the data cache ’ , \\ ‘ {ℓ}_{32 ( 4 )} : exclusivity ’ , ‘ {ℓ}_{32 ( 5 )} : replacement policy ’ , \\ ‘ {ℓ}_{32 ( 6 )} : size of the write memory buffer ’ , ‘ {ℓ}_{32 ( 7 )} : prefetch ’ \} \qquad ( 09 )$$

for the sub-parameter ‘ [symbol] ₃₃: instruction cache no. 2’ of the list L₃, the list L₃₃ may be:

$${L}_{33} = \{ ‘ {ℓ}_{33 ( 1 )} : cache line size ’ , \\ ‘ {ℓ}_{33 ( 2 )} : associativity ’ , ‘ {ℓ}_{33 ( 3 )} : size of the instruction cache ’ , \\ ‘ {ℓ}_{33 ( 4 )} : exclusivity ’ , ‘ {ℓ}_{33 ( 5 )} : replacement policy ’ , \\ ‘ {ℓ}_{33 ( 6 )} : size of the write memory buffer ’ , ‘ {ℓ}_{33 ( 7 )} : prefetch ’ \} \qquad ( 10 )$$

for the sub-parameter ‘ [symbol] ₃₅: size of the system level cache’ of the list L₃, the list L₃₅ may be:

$${L}_{35} = \{ ‘ {ℓ}_{35 ( 1 )} : cache line size ’ , ‘ {ℓ}_{35 ( 2 )} : associativity ’ , \\ ‘ {ℓ}_{35 ( 3 )} : \# system\_level \_cache \_slice ’ ‘ {ℓ}_{35 ( 4 )} : exclusivity ’ , \\ ‘ {ℓ}_{35 ( t )} : SLC slice ’ , ‘ {ℓ}_{35 ( 6 )} : latency ’ , ‘ {ℓ}_{35 ( 7 )} : replacement policy ’ , \\ ‘ {ℓ}_{35 ( 8 )} : size of the write memory buffer ’ , \\ ‘ {ℓ}_{35 ( 9 )} : prefetch ’ , ‘ {ℓ}_{35 ( 10 )} : SLC bandwidth ’ \} \qquad ( 11 )$$

A list Lₙₖ (and in particular a preceding list L₃ₖ) may thus comprise, according to the preceding enumerations (08), (09) and (10) and (11), cache line size, associativity, the size of the instruction and data cache, exclusivity, replacement policy, the size of the write memory buffer and/or the presence or absence of a prefetcher, etc. It will be noted that the expression ‘data replacement policy’ refers to one or more rules defining whether data are preserved or abandoned.

A list Lₙₖ (and in particular the preceding list L₃₅) may also comprise, according to the preceding enumeration (11), a system-level-cache slice (or SLC slice), SLC slice parameters, latency, and/or SLC bandwidth, etc. It will be noted that the sub-parameters or lists of values associated with latency or with any of the sizes may, for example, be discrete values.

An objective and/or constraint function Fₕ of a set (or list) F is defined to evaluate one or more optimization criteria of the circuit associated with an integrated-circuit configuration to be designed. The objective and/or constraint function Fₕ then corresponds to a mathematical formulation associated with one or more objectives and/or constraints of the integrated circuit to be designed.

It will be noted that there are a plurality Q of circuit optimization criteria C_{q}. The value Q is an integer greater than or equal to 3. In embodiments, the optimization criteria may comprise the following three main optimization criteria:
a first main circuit optimization criterion C₁ corresponding to the computational performance of the integrated circuit, which may for example be defined by a number of floating-point operations per second (abbreviated FLOPS), a time-related datum of the integrated circuit such as latency (in seconds) or an operating frequency (in Hz), or even a measurement of a memory size (in number of bits or bytes);
a second main circuit optimization criterion C₂ corresponding to the power consumption of the integrated circuit; and
a third main circuit optimization criterion C₃ corresponding to the surface area of the integrated circuit.

Advantageously, other circuit optimization criteria C_{q} may be defined, such as the price of the circuit, the environmental footprint of the circuit, the manufacturing time of the circuit, the security level of the circuit, etc.

For example and non-limitingly, the set F of objective and/or constraint functions Fₕ may comprise a first objective function F₁ associated with the first main optimization criterion C₁ corresponding to the computational performance of the integrated circuit. The first objective function F₁ may then be an argument of the maximum (or argmax) of the computational performance of the integrated circuit C₁, such as defined according to the following equation (12):

$${F}_{1} = arg max ( {C}_{1} ) \qquad ( 12 )$$

The list F may also comprise a second and a third objective function, F₂ and F₃, associated with the second and with the third main circuit optimization criteria C₂ and C₃, which correspond to the power consumption of the integrated circuit and to the surface area of the integrated circuit, respectively. The second objective function F₂ and the third objective function F₃ may then be an argument of the minimum (or argmin) of the power consumption of the integrated circuit C₂ and an argument of the minimum of the surface area of the integrated circuit C₃, such as defined according to the following equations (13) and (14)

$${F}_{2} = arg min ( {C}_{2} ) \qquad ( 13 )$$

$${F}_{3} = arg min ( {C}_{3} ) \qquad ( 14 )$$

As used here, in particular in equations (12), (13) and (14) above, the argmax and argmin functions refer to functions for determining the one or more minimum and maximum possible values of a variable represented by a data set, respectively.

In particular, it will be noted that an objective function of the list F is a function seeking to minimize or maximize a criterion expressed as an optimization objective of the circuit. A constraint function of the list F is a function seeking to meet a constraint of the integrated circuit to be designed. For example and non-limitingly, a constraint function Fₕ may then be an inequality between a plurality of parameters of the list P and/or sub-parameters of a list Lₙ. If the constraint corresponds to cache-size relationships for the data or instructions of levels 1, 2, and 3, constraint functions Fₕ may be defined according to the following expression (15):

$${ℓ}_{31 ( 3 )} \leq {ℓ}_{32 ( 3 )} , and {ℓ}_{32 ( 3 )} \leq {ℓ}_{33 ( 3 )} \qquad ( 15 )$$

Moreover, the exploration space E may be suitable for use by one or more optimization algorithms A.

As used here, the expression “optimization algorithm” refers to an algorithm executing an operational search OS (also called ‘combinatorial optimization’ or ‘decision support’) to analyse complex situations and in particular to generate one or more solutions to the problem of designing a hardware architecture to be optimized. An optimization algorithm may be any algorithm or mathematical model capable of determining various decision variables (i.e. parameters and sub-parameters) and various objective and/or constraint functions of an exploration space E related to the search for optimized solutions of an internal representation of an architecture design descriptor D.

For example and non-limitingly, the problem of designing a hardware architecture defined by the architecture design descriptor D may be equivalent to or similar to a known combinatorial-optimization problem, so that the mathematical representation of the problem, i.e. the exploration space E, may be transcribed and enriched in light of this known problem (linear problem, integer linear problem, graph, genome, etc.). In this case, an algorithm A known to effectively solve this known combinatorial-optimization problem may be applied (simplex, branch and bound algorithm, algorithm for finding shortest path, genetic algorithm, etc.). Thus, depending on the nature of the problem of designing a hardware architecture to be optimized, an optimization algorithm A may be suitable, and therefore the induced (architecture, micro-architecture or system) exploration space E may be generated automatically.

As shown in FIG. 1, the architecture-determining method comprises a step 110 of receiving the descriptor D of the computing architecture.

In step 120, the architecture exploration space E may be generated on the basis of the descriptor D of the computing architecture. In this step, the architecture exploration space may be constructed on the basis of the generic architecture descriptor, which in particular comprises at least one parameter of the circuit architecture to be explored.

As shown in FIG. 1, the method for designing integrated-circuit hardware architectures comprises a plurality of iterations of optimization steps 130 to 150 associated with a multi-criteria hardware-architecture design exploration.

In step 130, the operational-search optimization algorithm A is applied to the architecture exploration space E, so as to generate, in each iteration ‘i’ of the design method, one or more candidate architecture configurations Gᵢⱼ for the integrated circuit. The index ‘j’ is associated with various configurations generated in an iteration i. The number of candidate architecture configurations generated may be different in each iteration i. In particular, step 130 may determine at least two candidate architecture configurations to be evaluated, these being constructed on the basis of the circuit-architecture exploration space, using at least one optimization algorithm A.

A candidate architecture configuration Gᵢⱼ comprises a sub-set of the elements P certain decision variables or parameters of which are set. A candidate architecture configuration Gᵢⱼ may also comprise sub-sets of the elements L, certain sub-parameters of which are set. The candidate architecture configuration Gᵢⱼ then corresponds to a sub-set (i.e. an instance) of the architecture exploration space E. Each candidate architecture configuration Gᵢⱼ of the set of generated configurations is a single architecture configuration, and is therefore different from each of the configurations generated in the same iteration i and in preceding iterations [1, i−1].

Advantageously, the operational search may be applied hierarchically to the architecture exploration space E.

For example and non-limitingly, the first iteration or iterations (generally designated by the index i) of the design method may be configured to generate one or more candidate architecture configurations Gᵢⱼ associated with optimization of the parameters Pₙ of the list P. Likewise, for one or more configurations Gᵢⱼ selected to optimize the set of parameters Pₙ of the list P, one or more following iterations may be configured so as to generate, for each parameter Pₙ, one or more candidate architecture configurations Gᵢⱼ associated with the optimization of one or more sub-parameters [symbol] ₙₖ of the list Lₙ. And so on, for one or more configurations Gᵢⱼ selected to optimize the set of parameters Pₙ of the list P and the set of sub-parameters [symbol] ₙₖ of a list Lₙ, one or more subsequent iterations may be configured so as to generate, for each sub-parameter [symbol] ₙₖ, one or more candidate architecture configurations Gᵢⱼ associated with the optimization of one or more sub-parameters of the list Lₙₖ.

The optimization algorithm A applied in optimization step 130 of the method may be an optimization algorithm A selected from a set of optimization algorithms, which may for example be stored in an algorithm register RA.

Advantageously, the optimization algorithm A may be selected in step 120 from the algorithms of the set of algorithms stored in the register RA. The elements P, L and F of the architecture exploration space E may thus be generated on the basis of the architecture descriptor D and of the selected optimization algorithm A. The architecture exploration space E may then be used in step 130 by the selected optimization algorithm A.

In particular, the optimization algorithm A may be selected on the basis of the objectives and/or constraints of the integrated circuit to be designed. For example and non-limitingly, one design objective may be minimization of the latency of an integrated circuit. The integrated circuit may consist of a number of cores comprising a number X of routers. Each router is characterized by a spatial position in the circuit and may be connected to one or more routers by a connection. Such an objective of minimization of the latency of the circuit may correspond to the search for a topology of an optimized interconnection network between the routers in the circuit, i.e., to the search for the shortest connection path from an input (a first router) to an output (an Xth router), so as to distribute (or transmit) data as quickly as possible between routers through the circuit. In this case, the selected optimization algorithm A may advantageously be a graph-theory algorithm. In particular, the optimization algorithm A may comprise determining a graph comprising a certain number of points, such that each point corresponds to (or represents) the spatial position of a router in the integrated circuit. Optimization thus consists in determining the shortest path between each router pairwise, to obtain a minimized overall path between a first and an Xth router. Each path between two routers (i.e. an edge of the graph) corresponds to (or represents) a possible connection between two routers of the integrated circuit.

In embodiments, the optimization algorithm A may be selected on the basis of one or more objective functions Fₕ. For example, an optimization criterion C₄ may correspond to the latency of an integrated circuit, i.e. for example to the measurement of the number of “jumps” or connections (and/or the measurement of connection time) between the various elements of the circuit. An objective function F₄ may then be an argmin of the latency of the integrated circuit, such as defined according to the following equation (16):

$${F}_{4} = arg min ( {C}_{4} ) \qquad ( 16 )$$

In this case, the selected optimization algorithm A may be defined on the basis of the detection of an argmin associated with the circuit optimization criterion C₄.

The candidate architecture configurations Gᵢⱼ are generated in the first optimization step 130 using a set of characteristic parameters associated with one or more given architecture-configuration evaluation tools Oₘ among M architecture-configuration evaluation tools. The index ‘m’ associated with various parameters of evaluation tools Oₘ is thus an integer between 1 and M.

An evaluation tool Oₘ may be any computing tool suitable for analysing (or evaluating) an architecture configuration. An evaluation tool Oₘ has predefined input quantities V_{mg}, which correspond to the elements that must be supplied to this evaluation tool, and delivers as output one or more output quantities R_{mg}, which correspond to evaluation results. For a given architecture configuration Gᵢⱼ which it is desired to evaluate by means of an evaluation tool Oₘ, it is therefore necessary to provide this tool with the values of the input quantities V_{mg} associated with a given architecture configuration Gᵢⱼ. The evaluation tool Oₘ will deliver as output one or more values of the output quantities R_{mg}, corresponding to evaluation results obtained after analysis of the given architecture configuration Gᵢⱼ.

A set of characteristic parameters associated with an evaluation tool Oₘ may for example comprise the type of predefined input quantities V_{mg} and/or the type of predefined output quantities R_{mg}.

For example and non-limitingly, an evaluation tool Oₘ may be a functional instruction-set simulator, a memory-hierarchy simulator, an RTL-level architecture simulator (RTL being the acronym of Register Transfer Level), such as: VPSim, GEM5, Virtualizer or Vista, ModelSim or Questa, the open source computing tool DRAMSys or even DRAMPower, etc.

An evaluation tool Oₘ may also be an architecture compilation tool such as the tool ‘Design Compiler’ from Synopsys, or a memory and input/output oriented evaluation tool such as, for example, the open source computing tool CACTI.

In the example of an evaluation tool Oₘ of VPSim-simulator type, possible input quantities V_{mg} of the VPSim simulator may be parameters related to the hardware architecture of the integrated circuit, such as the ‘number of cores’ or the ‘type of cores’. In the example of an evaluation tool Oₘ of GEM5-simulator type, possible input quantities V_{mg} of the GEM5 simulator may be parameters related to the micro-architecture of the integrated circuit, such as sub-parameters associated with the micro-architecture of the cores, such as the sub-parameters ‘data prefetching’, ‘size and number of registers’, etc.

One example of an output quantity R_{mg} may be an estimate of the computational performance of the integrated circuit, or even evaluations of interconnection or memory access, for example in terms of number, time or power consumption.

In the example of an evaluation tool Oₘ of VPSim-simulator type, an output quantity R_{mg} of the VPSim simulator may be the execution time of an application on an architecture configuration Gᵢⱼ or more generally another architecture-related metric, such as the number of cache hits or the number of cache misses for example.

In embodiments, an evaluation tool Oₘ may also be associated with one or more operating quantities tm. An operating quantity tm may for example be associated with the analysis time (or exploration time limit) of an architecture configuration Gᵢⱼ by the evaluation tool Oₘ. Definition of the operating quantities tm may affect the value of the output quantities R_{mg} of the evaluation tool. The set of characteristic parameters associated with an evaluation tool Oₘ may for example also comprise operating quantities tm.

In embodiments, a plurality of evaluation tools Oₘ may be intended to evaluate the same output quantity R_{mg}, but deliver, after simulation/evaluation, different values of these output quantities R_{mg}, and each output quantity R_{mg} may further be associated with distinct operating quantities tm. For example, a VPSim simulator and a GEM5 simulator may each deliver an estimate of the computational performance of the integrated circuit. In respect of the GEM5 simulator, it may require a very long analysis time to obtain the performance estimate, thus slowing down the overall exploration of an architecture configuration Gᵢⱼ. In respect of an evaluation tool Oₘ of VPSim-simulator type, it may require a very short analysis time to obtain the performance estimate, thus speeding up the overall exploration of an architecture configuration Gᵢⱼ. A performance estimate delivered by the VPSim simulator may be qualified less accurate (or more approximate) with respect to an estimate delivered by the GEM5 simulator, then qualified more detailed. Other output quantities R_{mg} may be obtained from a VPSim simulator and/or a GEM5 simulator, such as the number of times certain resources are accessed, the type of access, etc.

The evaluation tools Oₘ may be selected beforehand from a set of available tools as a function of tool selection conditions.

An architecture configuration Gᵢⱼ may be represented by a data structure, such as a matrix, containing parameters selected and/or determined and/or computed on the basis of the architecture exploration space E. The remainder of the description will be given with reference to the case where the data structure of architecture configuration Gᵢⱼ is a parameter matrix, by way of non-limiting example.

According to certain embodiments, the parameter matrix of an architecture configuration Gᵢⱼ may be determined in step 130 with one or more selected evaluation tools Oₘ taken into account. In particular, the parameter matrix of an architecture configuration Gᵢⱼ may be determined by taking into account some at least of the possible input quantities V_{mg} of the one or more selected evaluation tools Oₘ.

For example and non-limitingly, assuming that the selected evaluation tools comprise a first evaluation tool O₁ (e.g. the VPSim simulator) and a second evaluation tool O₂ (e.g. the GEM5 simulator), an architecture configuration Gᵢⱼ may be generated in such a way as to comprise elements associated with possible input quantities V_{1g} of the first evaluation tool O₁ (VPSim simulator) and possible input quantities V_{2g} of the second evaluation tool O₂ (GEM5 simulator). In other words, if an evaluation tool does not allow differences between a plurality of values of a given parameter (or sub-parameter) of the exploration space E to be evaluated, then this parameter is not considered in the operation of generating an architecture configuration Gᵢⱼ to be evaluated. Thus, the operation of generating an architecture configuration Gᵢⱼ to be explored considers a sub-set of the exploration space E, to choose a new configuration to be simulated/evaluated taking into account the one or more evaluation tools used (or selected/chosen).

In embodiments, execution links between a selected first evaluation tool Oₘ and a selected or available second evaluation tool O₍ₘ₊₁₎ may be determined prior to step 130. For example and non-limitingly, the execution of a given selected evaluation tool O₃ may depend on certain values of input quantities V_{3g} not available in an architecture configuration Gᵢⱼ to be determined. In contrast, these values of input quantities V_{3g} of the selected evaluation tool O₃ may correspond to or be associated with values of output quantities R_{4g} accessible via the execution of another available evaluation tool O₄. In such an embodiment, in addition to the selection of the evaluation tool O₃, the other evaluation tool O₄ may also be selected from the set of available evaluation tools Oₘ, in response to the determination of this execution link between the evaluation tool O₃ and the other evaluation tool O₄.

In such an embodiment, the parameter matrix of an architecture configuration Gᵢⱼ may then comprise elements associated with possible input quantities V_{4g} of the evaluation tool O₄.

In step 140, the candidate architecture configurations Gᵢⱼ determined in step 130 are evaluated by a chosen plurality of evaluation tools Oₘ.

For each architecture configuration Gᵢⱼ to be evaluated, step 140 thus comprises the selection of elements included in the architecture configuration Gᵢⱼ that are required to determine the values of the input quantities V_{mg} of an evaluation tool Oₘ of the plurality of tools chosen for the evaluation of the candidate configurations Gᵢⱼ.

Moreover, in step 140, at least two evaluation tools of the chosen plurality of tools may be executed in parallel.

In embodiments, the evaluation tools Oₘ used in step 140 may be the evaluation tools Oₘ selected in step 130 and considered for the generation of the parameter matrix of an architecture configuration G.

In embodiments, the method may comprise, before the execution of the evaluation tools in step 140, a prior step of transformation (also called conversion, transcription, or translation) of at least some of the candidate architecture configurations Gᵢⱼ into input files that are comprehensible (i.e. readable or decryptable) by the evaluation tools Oₘ. In particular, an input file of an evaluation tool Oₘ may be generated on the basis of the transcription of the selection of elements of a candidate architecture configuration Gᵢⱼ into values of the input quantities V_{mg} of an evaluation tool Oₘ. This prior transformation step allows each candidate architecture configuration to be converted into a number of descriptions (represented for example by description files) suitable for the computing-architecture evaluation tools.

Such descriptions suitable for the computing-architecture evaluation tools may be of at least two description levels, the computing-architecture evaluation tools Oₘ evaluating at least two description levels of the integrated circuit.

In embodiments, the description levels of the integrated circuit may correspond to:
a high-level description of the complete integrated circuit,
a description of the architecture of the circuit described in terms of basic elements and including the interconnections between the basic elements, or
a description of the microarchitecture of the basic elements of the integrated circuit.

In embodiments, the prior configuration transformation step may be performed on the basis of a first translation register R_{T1} associated with one or more evaluation tools Oₘ. The first translation register RT may comprise transcription elements such as python scripts for example. The transcription elements associated with the selected evaluation tools Oₘ to be executed are then applied to a candidate architecture configuration Gᵢⱼ to generate input files for the evaluation tools Oₘ. The selection of the transcription elements associated with the evaluation tools Oₘ may depend on the candidate architecture configurations Gᵢⱼ determined in step 130 and/or on the evaluation tools Oₘ selected in step 140. For an evaluation tool of VPSim-simulator type for example, the input files may be determined on the basis of a python script generating a hardware platform suitable for the VPSim simulator (for example in terms of number of cores, type, memory parameters, NoC parameters, etc.).

In step 140, the execution of the evaluation tools thus delivers values of results of evaluation of each candidate architecture configuration Gᵢⱼ.

The prior transformation step, and the application of at least two of said circuit architecture evaluation tools to each of the candidate architecture configurations, allows evaluation results to be obtained and the candidate architecture configurations to be automatically compared during the execution of the method.

Advantageously, the method may comprise, after step 140 of evaluation of the candidate configurations by the chosen plurality of evaluation tools Oₘ, a step of receiving all the values of output quantities R_{mg}. The set of the values of output quantities R_{mg} thus corresponds to the results of evaluation, after analysis, of each architecture configuration G.

In embodiments in which at least some of the values of input quantities V_{mg} of the evaluation tools Oₘ chosen in step 130 depend on one or more possible output quantities R_{mg} of the evaluation tools Oₘ, step 140 may comprise, for each candidate configuration:
evaluating the candidate configuration Gᵢⱼ using a first group of the chosen plurality of evaluation tools Oₘ,
receiving the set of the values of output quantities R_{mg} corresponding to the results of evaluation after analysis of the architecture configuration Gᵢⱼ by the first group of the chosen plurality of evaluation tools Oₘ, then
evaluating the candidate configuration Gᵢⱼ using a second group of the chosen plurality of evaluation tools Oₘ, the second group of the plurality of evaluation tools Oₘ having a dependency relationship with the first group of the chosen plurality of evaluation tools Oₘ.

In embodiments, the method for determining hardware architecture may comprise a step of transforming (or transcribing or translating) the results of evaluation of the candidate architecture configurations G that were obtained in step 140 into input files for the evaluation tools Oₘ and/or into a mathematical representation usable to implement an operational search. The step of transforming the evaluation results may be performed on the basis of the first translation register R_{T1}. For example and non-limitingly, transcription elements associated with the evaluation tools Oₘ may be selected from the elements of the register R_{T1}, and applied to at least some of the evaluation results of evaluation tools Oₘ. The step of transforming the evaluation results may be an automatic conversion of the evaluation results into description files.

Application of a transcription element to at least some of the evaluation results may for example make it possible to generate one or more input files for other evaluation tools Oₘ to be executed.

Application of a transcription element to at least some of the evaluation results may also make it possible to generate, for example, one or more matrices associated with a mathematical representation usable in the context of the operational search 130. For example, the transformation of the evaluation results into a mathematical representation may correspond to their transformation into an (e.g. integer, binary, etc.) format that is usable via the execution of an optimization algorithm A.

The selection of the elements associated with the evaluation tools Oₘ in the step of transforming the evaluation results may depend on the candidate architecture configurations Gᵢⱼ determined and/or on the evaluation tools Oₘ chosen.

In step 150, two or more values of circuit optimization criteria C_{q} are determined on the basis of the results of evaluation of the candidate configurations Gᵢⱼ obtained in step 140.

Two optimization criteria of the set of optimization criteria of the circuit to be determined in step 150 may be chosen from antagonistic optimization criteria characterizing the integrated circuit to be designed, i.e. chosen from at least a main criterion of optimization of computational performance, a main criterion of optimization of power consumption and a main criterion of optimization of the surface area of an integrated circuit.

For example and non-limitingly, a circuit optimization criterion C_{q} may be the computational performance C₁ (in terms of computation execution time) associated with a candidate architecture configuration Gᵢⱼ. The value of the computational performance C₁ may be computed on the basis of the performance estimate determined by a first evaluation tool (for example the VPSim simulator) or by a second evaluation tool (for example the GEM5 simulator).

Furthermore, in step 150, at least one value of a defined circuit optimization criterion C_{q} among the set of circuit optimization criteria to be determined is computed by means of one or more analytical formulae (or analytical functions) denoted [symbol] . An analytical formula [symbol] , used in the computation of the value of a circuit optimization criterion C_{q}, takes as input parameters at least one circuit information item (generically denoted I_{c}) and at least one technological information item (generically denoted Iₜ).

A circuit optimization criterion C_{q} to be computed on the basis of an analytical function [symbol] may be the computational performance C₁, the (static and/or dynamic) power consumption C₂ of an integrated circuit to be designed and/or the surface area C₃ of this circuit, associated with a candidate architecture configuration Gᵢⱼ.

A circuit information item may be an information item related to the structure of the integrated circuit to be designed and/or an information item related to the operating activity of the integrated circuit to be designed. For example and non-limitingly, a structure-related information item may correspond to a number or type of constituent elements of an integrated circuit, such as a number or type of cores in the circuit. An information item related to operating activity may correspond to a number of times or a way in which memory is accessed, a number of times or a way in which a constituent element of the integrated circuit is accessed, a number of stresses or type of stress on a constituent element of the integrated circuit or a pipeline of constituent elements of the integrated circuit, a number or type of operations performed by the integrated circuit, etc. The type of information items related to operating activity that are available may depend on the design level of the integrated circuit. For example, the computational latency of a constituent element of the circuit may be an information item related to operating activity and allows a more global latency or a quantity related to power consumption to be computed using an analytical formulation [symbol] .

A circuit information item may be determined on the basis of one or more evaluation results obtained in step 140, i.e. of one or more values of output quantities R_{mg} obtained with at least one of the evaluation tools Oₘ.

A technological information item is determined on the basis of one or more technological databases. A technological database comprises data on constituent circuit elements able to be fabricated using a given integrated-circuit design technology. For example and non-limitingly, a technological information item may correspond to information on the performance, consumption or surface area of a constituent element of an integrated circuit. An element of an integrated circuit may be any “circuit brick” used to design the functionalities of the integrated circuit. Examples of elements of an integrated circuit are for example logic gates, memories, processors, circuits dedicated to a specific functionality such as imagers, displays, signal transmission/reception circuits, coprocessors, routers, computers, control circuits, test circuits, power management circuits, etc. These circuit elements may correspond to elementary bricks, for example an OR logic gate, or on the contrary to higher-level bricks such as a processor, a memory or a logic circuit able to be fabricated on the basis of the elementary bricks.

For each of these circuit elements, information on their performance, consumption, surface area, and/or other information associated with these elements, such as their cost, environmental impact, etc., may be extracted from one or more technological databases.

The surface area of a circuit element will thus potentially correspond to a 2D areal dimension, as seen from above (conventionally defined on the basis of a view known as the layout view visible in a GDSII file). The power-consumption information of an element is generally of two types. The first type corresponds to information on dynamic power consumption associated with an activity of the element, i.e. power consumption associated with a change of state of the elements (for example memory access, production of an image by an imager, computation by a coprocessor, etc.). The second type corresponds to information on the static power consumption of an element, i.e. any information on power consumption unrelated to dynamic power consumption (for example such as constant activity-independent power consumption). However, it will be noted that the static power consumption may depend on the activity of the element depending on whether certain consumption management techniques such as the DVFS technique, or even management of the body bias in FDSOI, are taken into account. The performance information may correspond to information related to a time-domain concept, for example such as a propagation time through a circuit element for performance of a task, an operating frequency of a circuit element, a latency of a processing pipeline including at least one circuit element, etc.

Such technological databases may be constructed and/or determined and/or obtained from suppliers (or supplier catalogues) and/or manufacturers of integrated circuits. These databases may also be built, for example before or during the design method, using simulation/evaluation/synthesis tools, on the basis of lower level supplier and/or manufacturer data, and for example on the basis of a manufacturer-supplied design kit. To build these technological databases allowing technological information items to be obtained, an architectural model resulting from pre-execution of a computing tool may be used. Such a computing tool may for example be an architecture compilation tool such as the tool ‘Design Compiler’ from Synopsys, models of the surface area (or size) of available constituent elements, or even high-level simulations carried out beforehand by means of dedicated simulators, for example a consumption evaluation tool such as the open source computing tool CACTI associated with information on the cache memories, or the computing tool ‘PrimePower’ from Synopsys. Furthermore, during the design method, these technological databases may be enriched with at least some of the circuit information items determined and/or refined in each iteration i.

In addition, a technological database may be configured to search for and retrieve (via the application of queries for example) one or more technological information items on the basis of one or more values of output quantities R_{mg} obtained from at least one of the executed evaluation tools Oₘ, and/or of elements of the associated candidate configuration Gᵢⱼ.

In embodiments, the step of determining the value of the circuit optimization criterion C_{q} may be performed using a function register [symbol] . The function register [symbol] is associated with the analytical formulae [symbol] to be applied to the circuit and technological information items to compute a value of the circuit optimization criterion C_{q}.

In particular, an analytical function [symbol] may be any function allowing circuit and technological information items to be processed. For example, an analytical function may comprise a sum of parameters, a division, a subtraction, and/or a multiplication, etc.

For example and non-limitingly, to determine a value of the third main circuit optimization criterion C₃, which corresponds to the surface area of the integrated circuit, an analytical function [symbol] may be a sum taking as arguments the sum of the surface areas of the elements of the circuit. To determine a value of the second main circuit optimization criterion C₂, which corresponds to the power consumption of a computing element of the integrated circuit, an analytical function [symbol] may be a multiplication taking as arguments the number of times each operation is activated and their average power consumption.

It will be noted that a value of a defined circuit optimization criterion C_{q} among the set of the optimization criteria of the circuit to be determined may be obtained directly from values of output quantities R_{mg} after analysis of an architecture configuration Gᵢⱼ by a chosen evaluation tool Oₘ. The evaluation tool Oₘ may then use technological databases for its internal operation. In this case, the value of the circuit optimization criterion C_{q} is not obtained by an analytical function [symbol] executed after analysis by the evaluation tool.

For example and non-limitingly, the value of the computational performance C₁ or of the power consumption C₂ may be computed on the basis of the combination of results obtained by the evaluation tool (for example the VPSim simulator and/or GEM5 simulator) with information obtained through the exploitation of technological databases. In particular, such an evaluation tool delivering a result said to be functional (such as a number of operations, number of times accessed, number of cycles) may be configured on the basis of a technological database, for example to generate maximum frequencies achievable by components of the circuit.

In step 150, the one or more analytical formulae to be applied are selected from the function register [symbol] on the basis of the circuit optimization criterion C_{q} to be determined.

In embodiments, the one or more analytical formulae [symbol] to be applied may further be selected on the basis of the circuit information items I_{c} available after the evaluation of the candidate architecture configurations Gᵢⱼ.

The value of at least one circuit optimization criterion C_{q} may be determined on the basis of a selected analytical function [symbol] taking as arguments:
one or more circuit information items I_{c} obtained from at least one result of an evaluation tool (and optionally of information derived from the candidate architecture configuration Gᵢⱼ), and
one or more technological information items It obtained from at least one technological database.

Thus, the value of a circuit optimization criterion C_{q} may be defined according to the following equation (17):

$${C}_{q} = ℱ ( {I}_{c} , {I}_{t} ) \qquad ( 17 )$$

For example and non-limitingly, the evaluation of a candidate architecture configuration Gᵢⱼ by a first evaluation tool O₁ may generate values of output quantities R_{1g}. A circuit information item I_{c1} may then be derived from the values of output quantities R_{1g}. The value of a circuit optimization criterion C_{q} may thus be determined on the basis of a selected analytical function [symbol] taking as arguments the circuit information item I_{c1} and a technological information item Iₜ₁ according to the following equation (18):

$${C}_{q} = ℱ ( {I}_{c 1} , {I}_{t 1} ) \qquad ( 18 )$$

The evaluation of a candidate configuration Gᵢⱼ by a second evaluation tool O₂ may generate values of output quantities R_{2g}. A circuit information item I_{c2} may then be derived from the values of output quantities R_{2g}. The value of a circuit optimization criterion C_{q} may thus be determined on the basis of the selected analytical function [symbol] taking as arguments the circuit information item I_{c1}, the technological information item Iₜ₁ and the circuit information item I_{c2} according to the following equation (19):

$${C}_{q} = ℱ ( {I}_{c 1} , {I}_{t 1} , {I}_{c 2} ) \qquad ( 19 )$$

In embodiments, the value of a circuit optimization criterion C_{q} may be determined on the basis of values of output quantities R_{mg} obtained through the combined execution of two or more evaluation tools Oₘ. For example and non-limitingly, the evaluation of a candidate configuration Gᵢⱼ by an evaluation tool O₄ may deliver the values of output quantities R_{g4} that are themselves used for the evaluation of the candidate configuration Gᵢⱼ by an evaluation tool O₃ that delivers as output the values of output quantities R₉₃. A circuit information item I_{c3} may then be derived from the values of output quantities R_{g3}. A technological information item Iₜ₃ may also be derived from the values of output quantities R_{g3} and/or R_{g4}, and/or from the elements of the candidate architecture configuration Gᵢⱼ. The value of a circuit optimization [symbol] criterion C_{q} may thus be determined on the basis of a selected analytical function taking as arguments the circuit information item I_{c3} and the technological information item Iₜ₃, according to the following equation (20):

$${C}_{q} = ℱ ( {I}_{c 3} , {I}_{t 3} ) \qquad ( 20 )$$

It will be noted that the various embodiments in respect of determining the value of a circuit optimization criterion C_{q} may be implemented separately or be combined.

The value of the first main criterion of optimization of computational performance C₁ of the circuit (for example the overall latency of a processing pipeline) may for example be computed by applying a selected analytical function [symbol] taking as arguments a plurality of latency information items obtained via the execution of simulators (for example VPSim and/or GEM5) and the exploitation of the technological database.

The value of the second main criterion of optimization of the power consumption C₂ of the circuit may for example be computed by applying a selected analytical function [symbol] taking as arguments a list of elements of the integrated circuit and the associated power consumption of these various elements, which is accessible from an existing database or, if it is not accessible from an existing database, by generating/populating such a database on the basis of results of consumption simulations allowing these technological information items to be obtained. It is generally possible to obtain an analytical function [symbol] that takes as argument the number of times the interconnection between the constituent elements of the circuit or of one of the parts thereof is accessed or the number of times memory is accessed (for example obtained via the VPSim simulator), and the power consumption per access obtained through the exploitation of the technological database (for example database built with the tool CACTI).

The value of the third main criterion of optimization of the surface area C₃ of the circuit may for example be computed by applying a selected analytical function [symbol] . Such an analytical function [symbol] takes as arguments parameters originating from the architecture configuration to be evaluated (for example, the number of processor cores and their configuration, the number of cache memories and their configuration), results originating from evaluation tools (for example, the surface area of a cache memory, which is for example obtained via the tool CACTI) and results obtained through the exploitation of technological databases (for example a database determined on the basis of a model for obtaining the size of the microprocessors, often expressed in mm²). It will be noted that the tool CACTI itself relies on technological databases. Such an analytical function [symbol] may also take as arguments results of a summary report (for example delivered by the tool ‘Design Compiler’ for a low-level architecture description).

Thus, the value of the third main criterion of optimization of the surface area C₃ of the circuit may for example be computed by applying an analytical function [symbol] defined according to the following expression:

$$ℱ = ( ‘ number of cores ’ \times ‘ surface area of a core ’ ) + ( ‘ number of cache memories ’ \times ‘ surface area of a cache memory ’ ) + ‘ surface area of the remainder ’ .$$

In the preceding expression, the arguments associated with the term “number of” refer to parameters originating from the architecture configuration to be evaluated, which is obtained by applying the algorithm A. Moreover, in the preceding expression, the argument “surface area of the remainder” refers to the result of the addition of the surface areas of the elementary components of the integrated circuit other than the cores or cache memories (i.e. interconnections, peripherals, etc.).

In embodiments, the evaluation results generated by the plurality of evaluation tools Oₘ and/or the values of the circuit optimization criteria C_{q} associated with each candidate architecture configuration Gᵢⱼ may be stored in a memory of candidate configuration data. For example and non-limitingly, if in a current iteration of the optimization steps of the method it is determined that a candidate architecture configuration Gᵢⱼ is identical to an architecture configuration Gᵢⱼ determined beforehand in a previous iteration, the optimization step 140 of the method may be implemented using the data stored in the memory of candidate configuration data, in relation with the architecture configuration Gᵢⱼ determined beforehand in the previous iteration (and in particular the values of circuit optimization criteria C_{q} computed beforehand in association with the configuration).

In step 160, it is determined whether a termination criterion of the plurality of iterations of optimization steps is met.

In embodiments, the termination criterion may relate to the evaluation of one or more objective functions Fₕ defined in the architecture exploration space E with respect to the determined values of the circuit optimization criteria C_{q}.

In embodiments, the termination criterion may be defined as a function of a predefined execution time of the plurality of iterations of optimization steps and/or of a number of iterations executed. For example, it may be determined that the termination criterion is met if the predefined execution time has expired.

If it is determined that the termination criterion has not been met in step 160, a new iteration of the optimization steps 130 to 150 is implemented.

If it is determined that the termination criterion has been met in step 160, the iterations of the optimization steps 130 to 150 are stopped and step 170 is executed.

In step 170, one or more optimized computing-architecture configurations Gₒₚₜ are generated. An optimized configuration Gₒₚₜ is generated, in step 170, on the basis of the candidate architecture configurations Gᵢⱼ determined in step 130 of at least one of the executed iterations i of the optimization steps of the method and of the values of the circuit optimization criteria C_{q} determined in step 150 of the last iteration of the optimization steps 130 to 150.

Step 170 allows the configurations that are optimized in terms of multi-level digital-circuit hardware architecture to be generated automatically (170).

Advantageously, in the first iteration of optimization steps 130 to 150, a candidate architecture configuration Gᵢⱼ determined in optimization step 130 may be an architecture configuration Gi called the ‘initialization architecture configuration’. In the second iteration of optimization steps 130 to 150, in step 130, the optimization algorithm A is applied so as to generate one or more candidate architecture configurations Gᵢⱼ on the basis of the architecture exploration space E, of the initialization architecture configuration Gi and of the determined values of the circuit optimization criteria C_{q} (i.e. for example as a function of the results of evaluation of the initial architecture configuration that were generated by the plurality of evaluation tools Oₘ). In subsequent iterations of optimization steps 130 to 150, in the first optimization step 130, the optimization algorithm A is applied so as to generate one or more candidate architecture configurations Gᵢⱼ on the basis of the architecture exploration space E, of architecture configurations Gᵢⱼ generated in a previous iteration of optimization steps 130 to 150 (for example, the initialization architecture configuration Gi) and of the determined values of the circuit optimization criteria C_{q}.

For example and non-limitingly, step 130 of a current iteration of the optimization steps may comprise modification operations that modify the elements of the parameter matrix (for example ‘number of cores’, sub-parameters of the NoC, etc.) of the initialization architecture configuration Gᵢ and/or of the architecture configuration Gᵢⱼ of the previous iteration. These modification operations may be applied in a variable and/or predefined neighbourhood of the elements of the parameter matrix. These modification operations may be determined on the basis of the evaluation of one or more optimization criteria Cₕ defined in the architecture exploration space E with respect to the determined values of the circuit optimization criteria C_{q}. Furthermore, since the exploration of hardware-architecture design is generally multi-criteria exploration, the modification operations may be determined using a comparison between various evaluations of optimization criteria Cₕ, this making it possible to dynamically generate the Pareto front (also called the Pareto optimum) generally used in the context of the field of operational searches.

In one example of embodiment, a circuit optimization criterion may be the computational performance C₁ and an objective function may be the argument of the maximum of the computational performance of the integrated circuit F₁=argmax (C₁). In one embodiment, optimization step 130 may comprise comparing the value of the circuit optimization criterion C₁ over a certain number of successive iterations associated with modified architecture configurations Gᵢⱼ, so as to evaluate whether computational performance is increasing and therefore whether the objective function F₁ associated with the argument of the maximum of the computational performance is verified.

In embodiments, the method for designing integrated-circuit hardware architectures according to the embodiments may comprise a step of sorting and/or classifying the candidate architecture configurations Gᵢⱼ (determined in one or more iterations of optimization steps 130 to 150). The sorting step may be performed (or executed) as a function of the one or more determined values of the circuit optimization criteria C_{q} and/or of the evaluation of one or more objective and/or constraint functions Fₕ defined in the architecture exploration space E with respect to the determined values of the circuit optimization criteria C_{q}.

Furthermore, the sorting step may be performed so as to keep the architecture configurations Gᵢⱼ said to be ‘dominant’. A dominant architecture configuration G_{d} is an architecture configuration defined with respect to at least one ancillary architecture configuration Gₐ. The dominant architecture configurations G_{d} and the ancillary architecture configurations Gₐ are evaluated in the same optimization iteration or in two different optimization iterations. The configuration evaluation results of a dominant architecture configuration G_{d} induce better evaluation of all the objective and/or constraint functions Fₕ than the evaluation of all the objective and/or constraint functions Fₕ induced by the configuration evaluation results obtained with an ancillary architecture configuration Gₐ.

The classification step may be performed so as to order the architecture configurations Gᵢⱼ as a function of the evaluation of one or more objective and/or constraint functions Fₕ defined in the architecture exploration space E with respect to the determined values of the circuit optimization criteria C_{q} associated with these configurations.

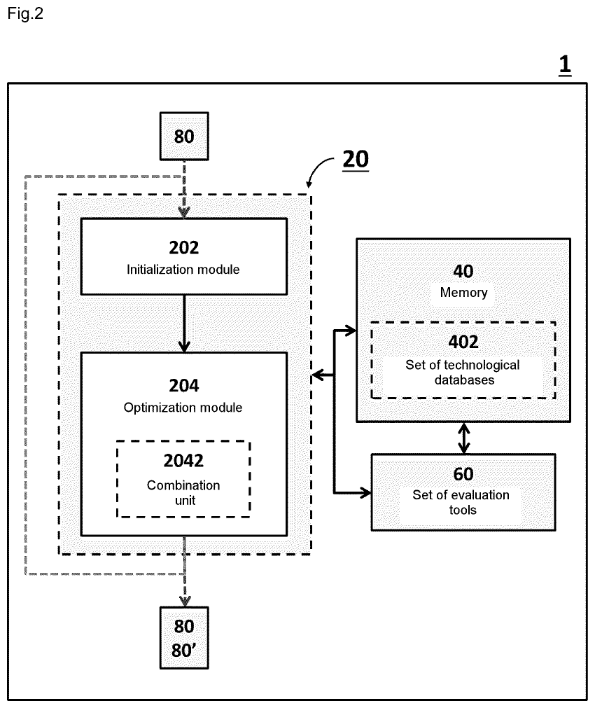

FIG. 2 shows one example of a system 1 for designing the hardware architecture of an integrated circuit in which the method for designing integrated-circuit hardware architectures may be implemented.

The system 1 for designing the hardware architecture of an integrated circuit comprises a device 20 for determining hardware architecture and a memory 40. The device 20 may comprise an initialization module 202 configured to generate an architecture exploration space E, for example on the basis of the architecture descriptor D, and an optimization module 204 configured to implement the method for designing integrated-circuit hardware architectures.

In embodiments, the memory 40 may comprise the algorithm register RA associated with the optimization algorithms used to select an algorithm A in step 130.

As shown in FIG. 2, the system 1 may comprise a set 60 of available evaluation tools Oₘ. The optimization module 204 may be configured to select one or more evaluation tools Oₘ from the set of available evaluation tools Oₘ to generate the parameter matrix of architecture configuration Gᵢⱼ in step 140.

In embodiments, the optimization module 204 may also be configured to determine the execution links between a selected evaluation tool Oₘ and another selected or available evaluation tool Oₘ.

In embodiments, the memory 40 may also comprise, associated with one or more evaluation tools Oₘ, the first translation register R_{T1}, which may be used by the optimization module 204 to select the transcription elements associated with the evaluation tools Oₘ in step 140.

In embodiments, the optimization module 204 may also comprise a combination unit 2042 configured to compute values of the circuit optimization criteria C_{q} in step 150.

According to certain embodiments, the memory 40 may also comprise the set of technological databases 402 and the function register RF used by the combination unit 2042 to compute values of the circuit optimization criteria C_{q} in step 150.

In particular, a technological database may comprise a plurality of databases of different natures. Such databases may contain textual or numerical data. Such databases may be databases of so-called design data usable by various digital-circuit design tools and having various formats associated with these tools. Such databases may also comprise, for various circuit bricks (memory, processor, logic gates, logic functions) associated with a design database, TLM files (TLM standing for Transaction Level Model), RTL files, layout files providing representations of masks for fabrication in a given technology, a process design kit (abbreviated PDK) comprising files providing propagation delay times, files providing a model of physical behaviour, etc. Such files may be in “.db” format or in “lib” format for example.

The memory 40 may further comprise the memory of candidate configuration data, which is configured to store the evaluation results generated by the executed plurality of evaluation tools Oₘ and/or the values of the circuit optimization criteria C_{q} associated with each candidate architecture configuration G.

Use of a memory of candidate configuration data makes it possible to speed up the exploration of the various established architecture configurations Gᵢⱼ (to be evaluated) with a view to generating an optimized integrated circuit.

In embodiments, the system 1 may comprise one or more data input/output interfaces, such as human-machine interfaces 80 (HMIs). These human-machine interfaces may comprise one or more acquisition means or means for transmitting information, such as input and control devices (for example a microphone, loudspeaker and keyboard), and/or one or more display devices (for example a video screen, touch screen, etc.). For example and non-limitingly, the system 1 may comprise a human-machine interface 80 configured to acquire an architecture descriptor D supplied by a user of the system 1 in the form of a computation architecture template.

In embodiments, the memory 40 may contain a second translation register R_{T2} associated with one or more computation architecture templates and the initialization module 202 may be configured to select a computation architecture template from among the templates of the register R_{T2}. The computation architecture template may be selected as a function of the architecture descriptor D. The initialization module 202 may thus be configured to generate the elements P, L and F of the architecture exploration space E on the basis of the architecture descriptor D and of the selected template of the second translation register R_{T2}.

In embodiments, the system 1 may comprise a transformation tool 80′ configured to transform the optimized configuration Gₒₚₜ into a hardware-architecture description file (also referred to as a ‘hardware description file’) at the RTL level defining the behaviour of a circuit and directly convertible into combinatorial logic gates and sequential elements (flip-flops, etc. . . . ). A description of a hardware architecture at the RTL level, called a low-level description, may for example be defined in a hardware description language (HDL) such as Verilog or VHDL.

In embodiments, the initialization module 202 may be configured to receive one or more optimized configurations Gₒₚₜ and to generate an architecture exploration space E on the basis of the one or more optimized configurations Gₒₚₜ, similarly to how the architecture exploration space E is generated on the basis of the architecture descriptor D.

In embodiments, the memory 40 may comprise a data register RD associated with parameters to be optimized of the integrated circuit to be designed and the initialization module 202 may thus be configured to generate the elements P, L and F of the architecture exploration space E on the basis of the architecture descriptor D or of optimized configurations Gₒₚₜ, and of some or all of the parameters of the data register RD.

The exploitation of optimized configurations Gₒₚₜ pre-generated by series of iterations of optimization steps performed by implementing the method for determining hardware architecture according to the embodiments of the invention allows multi-level management of the design of integrated-circuit hardware architectures. In this case, the set 60 of the design system 1 may comprise evaluation tools exploitable as a function of various architecture-configuration description levels or of one or more constituent elements of an architecture configuration. In such an embodiment, the set of translation registers, data registers and optimization algorithms may be tailored to the evaluation tools and to each of the various architecture-configuration description levels exploitable by the evaluation tools. In the same way, the set of technological databases 402 may comprise databases suitable for the various architecture-configuration description levels. Advantageously, certain evaluation tools and certain technological databases may respectively be exploitable and used on a multitude of hardware-architecture design levels.

Those skilled in the art will understand that the invention may be computer-implemented, in particular in the form of a computer program comprising instructions for the execution thereof. The computer program may be recorded on a processor-readable recording medium. Reference to a computer program that, when it is executed, performs any one of the functions described above, is not limited to an application program running on a single host computer. On the contrary, the terms computer program and software are used here in a general sense to refer to any type of computer code (for example application software, firmware, microcode, or any other form of computer instruction) that may be used to program one or more processors to implement aspects of the techniques described here. The computing means or resources may notably be distributed (cloud computing), possibly using peer-to-peer technologies.

The software code may be executed on any suitable processor (for example a microprocessor) or processor core or set of processors, be these provided in a single computing device or distributed among multiple computing devices (for example as possibly accessible in the environment of the device). The executable code of each program allowing the programmable device to implement the processes according to the invention may be stored for example in the hard drive or in read-only memory. Generally speaking, the one or more programs will be able to be loaded into one of the storage means of the device before being executed. The central processing unit is able to command and direct the execution of the instructions or segments of software code of the one or more programs according to the invention, which instructions are stored in the hard drive or in the read-only memory or else in the other abovementioned storage elements.

The method for determining hardware architectures may be implemented on a distributed computing unit comprising a plurality of physical cores. The embodiments of the invention are particularly suitable for such a distributed implementation, as well as for porting to multi-core hardware technologies. The method for determining hardware architectures according to the embodiments of the invention may be implemented in the form of computer code (which may in particular consist of a hardware-abstraction language) in various languages, such as the language C++, Python, Chisel, pyMTL, spinal-HDL, etc.

The invention is not limited to the embodiments and examples described above by way of non-limiting example. The invention encompasses all the variant embodiments envisageable by those skilled in the art.

1. A computer-implemented method for determining a hardware architecture for an integrated circuit, wherein the method comprises at least a plurality of iterations of the following steps:
applying an optimization algorithm A to an architecture exploration space E, so as to determine at least one candidate architecture configuration G, said candidate architecture configuration G belonging to said architecture exploration space E, said architecture exploration space E containing a set of objective functions F evaluating optimization criteria C_{q} associated with said candidate architecture configuration G;
applying said candidate architecture configuration G to a plurality of evaluation tools Oₘ, this delivering results of evaluation of the candidate architecture configurations G, an evaluation tool being a computing tool configured to analyse an architecture configuration in response to input-quantity values associated with the architecture configuration;
determining a value of at least two optimization criteria C_{q} of said optimization criteria C_{q}, said at least two optimization criteria, which are called the main optimization criteria, being chosen from the computational performance, power consumption and/or surface area of said integrated circuit to be designed, the value of one of said main optimization criteria being determined by applying an analytical function taking as arguments at least one circuit information item and at least one technological [symbol] information item, a circuit information item being an information item related to the structure of the integrated circuit and/or an information item related to the operating activity of the integrated circuit, and a technological information item being determined on the basis of one or more technological databases, said at least one circuit information item being determined on the basis of the evaluation results delivered by at least one evaluation tool Oₘ among said evaluation tools Oₘ, said at least one technological information item being obtained from at least one technological database; and
determining whether a termination criterion is verified; and in that, in each iteration, the determination of said candidate architecture configuration G is optimized on the basis of the evaluation of the objective functions F relating to said determined values of said at least two main optimization criteria C_{q}; the method further comprising terminating said iterations in response to the verification of said termination criterion and generating at least one optimized computing-architecture configuration Gₒₚₜ on the basis of said at least one architecture configuration G, said method being applicable to various levels in the architecture of the integrated circuit.

2. The method according to claim 1, wherein said termination criterion is defined as a function of an evaluation of at least one objective function Fₕ relating to a main optimization criterion C_{q}, on the basis of the determined value of said main optimization criterion.

3. The method according to claim 1, wherein said termination criterion is defined as a function of a predefined execution time of said plurality of iterations of optimization steps.

4. The method according to claim 1, wherein each evaluation tool Oₘ is configured to generate a set of evaluation results R_{mg} associated with said at least one architecture configuration G, and wherein the method further comprises a step of applying said candidate architecture configuration G to a first evaluation tool Oₘ among said evaluation tools Oₘ, on the basis of at least one evaluation result R_{mg} obtained in a prior step of applying said candidate architecture configuration G to a second evaluation tool Oₘ among said evaluation tools Oₘ.

5. The method according to claim 1, wherein said at least one architecture configuration G is generated as a function of said plurality of usable evaluation tools Oₘ.

6. The method according to claim 1, wherein the method further comprises a prior step of receiving an architecture descriptor D and a step of generating said architecture exploration space E on the basis of said architecture descriptor D and of said optimization algorithm A.

7. The method according to claim 1, wherein one evaluation tool Oₘ of said plurality of evaluation tools Oₘ is an evaluation tool chosen from an architecture configuration simulator, an architecture compilation tool, a consumption evaluation tool, a tool based on an exploitation of a database and a tool based on an exploitation of a memory of candidate configuration data, said memory of candidate configuration data being used to save evaluation results obtained in the step of applying candidate architecture configurations G and/or in the step of determining the value of optimization criteria C_{q} of candidate architecture configurations G.

8. The method according to claim 1, wherein said plurality of evaluation tools comprises evaluation tools exploitable as a function of various description levels of architecture configurations or of one or more constituent elements of an architecture configuration.

9. An integrated-circuit hardware architecture obtained by implementing the method according to claim 1.

10. The method for designing an integrated circuit, comprising implementing an integrated circuit on the basis of the integrated-circuit hardware architecture of claim 9.

11. A computer program product comprising program code instructions implementable by a computer, the computer being able to implement the method according to claim 1.
